(19) United States
(12) Patent Application Publication
(10) Pub. No.: US 2026/0147907 A1
(43) Pub. Date: May 28, 2026

(54) SYSTEMS AND METHODS FOR CONTROLLING ACCESS TO ELECTRONIC FILES USING CATEGORIES AND CATEGORY TYPES

(71) Applicants: Getac Technology Corporation, Taipei City (TW); WHP Workflow Solutions, Inc., North Charleston, SC (US)

(72) Inventor: Muhammad Adeel, Edina, MN (US)

(73) Assignees: Getac Technology Corporation, Taipei City (TW); WHP Workflow Solutions, Inc., North Charleston, SC (US)

(21) Appl. No.: 19/314,458

(22) Filed: Aug. 29, 2025

Related U.S. Application Data
(60) Provisional application No. 63/723,843, filed on Nov. 22, 2024.

(51) Int. Cl. G06F 21/60; G06F 21/62

(52) U.S. Cl. CPC G06F 21/604; G06F 21/602; G06F 21/6209

(57) ABSTRACT

The method for access control to electronic files includes: receiving an access request for an electronic file, the access request includes permission for an access category, the electronic file associated with file categories, and each of file categories associated with a first type or a second type of authority; determining whether any of file categories is associated with the second type of authority; and responsive to one of the file categories associated with second type of authority: determining whether the access category is associated with the second type of authority; responsive to the access category not associated with second type of authority, sending a first access rejection, otherwise determining whether the access category is a same category as the one of the file categories; and responsive to the access category is same category as one of the file categories, sending an access grant, otherwise sending a second access rejection.

### CROSS REFERENCE TO RELATED APPLICATIONS

The present application claims the benefit of priority to U.S. Provisional Application No. 63/723,843 , filed on Nov. 22, 2024, the entire contents of which are incorporated herein by reference.

### TECHNICAL FIELD

The present disclosure relates to a system and method for access control, and more particularly related to a system and method for access control of electronic files using categories and category types.

### DESCRIPTION OF RELATED ART

The increasing use of electronic files requires more and more intelligent mechanisms for protecting electronic files from unauthorized access. Currently, access control for electronic files is generally carried out by using category tags. The users can have access to an electronic file if they have permission to view a category tagged with the electronic file.

However, such a method requires selecting every category for each of a plurality of users or user groups to control access, which is time-consuming. Specifically, an electronic file may be tagged with a plurality of categories based on the electronic file's nature and/or type, retention period, and user permission. The electronic file may require or become required to have special authorization to access at a certain time. It may take a lot of time to reconfigure access control for the electronic file again because a system administrator may need to create a special category for the electronic file and may also need to withdraw permission from those user groups that do not have the special authorization. Moreover, when the electronic file may no longer need the special authorization to access later, the system administrator may need to reconfigure the access control of the electronic file. It may result in complex access control configurations.

In view of this, the present disclosure provides a method and system for access control of an electronic file to solve the above problems.

### SUMMARY

The foregoing presents a summary of the disclosure in order to provide the reader with a basic understanding. Accordingly, this disclosure provides an authorization method, an authorization system, and an electronic device utilizing it.

Consistent with embodiments of the present disclosure, there is provided a system for access control to electronic files that may include a memory storing instructions and at least one processor coupled to the memory, the at least one processor configured to execute the instructions to receive an access request for an evidence file. The access request includes a permission for an access category. The evidence file is associated with one or more file categories. Each of the one or more file categories is associated with a first type of authority or a second type of authority. The at least one processor may also be configured to execute the instructions to determine whether any of the one or more file categories is associated with the second type of authority. The at least one processor may also be configured to execute the instructions to, in response to a determination that one of the one or more file categories is associated with the second type of authority: determine whether the access category is associated with the second type of authority; in response to a determination that the access category is not associated with the second type of authority, send a first access rejection; and in response to a determination that the access category is associated with the second type of authority: determine whether the access category is a same category as the one of the one or more file categories; in response to a determination that the access category is the same category as the one of the one or more file categories, send an access grant; and in response to a determination that the access category is different from the one of the one or more file categories, send a second access rejection.

Consistent with embodiments of the present disclosure, there is provided a method for access control to electronic files that may include receiving an access request for an electronic file, wherein the access request includes a permission for an access category, the electronic file is associated with one or more file categories, and each of the one or more file categories is associated with a first type of authority or a second type of authority; determining whether any of the one or more file categories is associated with the second type of authority; and responsive to a determination that one of the one or more file categories is associated with the second type of authority: determining whether the access category is associated with the second type of authority; responsive to a determination that the access category is not associated with the second type of authority, sending a first access rejection; and responsive to a determination that the access category is associated with the second type of authority: determining whether the access category is a same category as the one of the one or more file categories; responsive to a determination that the access category is the same category as the one of the one or more file categories, sending an access grant; and responsive to a determination that the access category is different from the one of the one or more file categories, sending a second access rejection.

Consistent with embodiments of the present disclosure, there is provided a non-transitory computer-readable medium storing instructions which, when executed, cause at least one processor to perform operations for access control to electronic files, the operations comprising: receiving an access request for an electronic file, wherein the access request includes a permission for an access category, the electronic file is associated with one or more file categories, and each of the one or more file categories is associated with a first type of authority or a second type of authority; determining whether any of the one or more file categories is associated with the second type of authority; and responsive to a determination that one of the one or more file categories is associated with the second type of authority: determining whether the access category is associated with the second type of authority; responsive to a determination that the access category is not associated with the second type of authority, sending a first access rejection; and responsive to a determination that the access category is associated with the second type of authority: determining whether the access category is a same category as the one of the one or more file categories; responsive to a determination that the access category is the same category as the one of the one or more file categories, sending an access grant; and responsive to a determination that the access category is different from the one of the one or more file categories, sending a second access rejection.

Furthermore, embodiments of the present disclosure may also include computer systems, apparatus, processes, and computer programs recorded on one or more computer storage devices, each configured to perform the actions disclosed in the present disclosure.

It is to be understood that the foregoing general description and the following detailed description are exemplary and explanatory only and are not restrictive of the disclosed embodiments.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A is a schematic diagram of a system for access control of electronic files according to some embodiments of the present disclosure.

FIG. 1B is a schematic diagram of a system for access control of electronic files according to another embodiment of the present disclosure.

FIG. 2 illustrates an example of a user interface for managing a permission for an access category of a user group for access to electronic files according to some embodiments of the present disclosure.

FIG. 3 is a flowchart diagram of a method for access control to electronic files in accordance with some embodiments of the present disclosure.

FIG. 4 is a flowchart diagram of a method for access control to electronic files when file categories are not associated with the second type of authority in accordance with some embodiments of the present disclosure.

FIG. 5 is a flowchart diagram of a method for access control to electronic files in accordance with another embodiment of the present disclosure.

### DETAILED DESCRIPTION

In the present disclosure, when an element is referred to as “connected” or “coupled”, it may mean “electrically connected” or “electrically coupled”. “Connected” or “coupled” can also be used to indicate that two or more components operate or interact with each other. In addition, although the terms “first”, “second”, and the like are used in the present disclosure to describe different elements, the terms are used only to distinguish the elements or operations described in the same technical terms. The use of the term is not intended to be a limitation of the present disclosure.

Unless otherwise defined, all terms (including technical and scientific terms) used in the present disclosure have the same meaning as commonly understood by the ordinary skilled person to which the concept of the present disclosure belongs. It will be further understood that terms (such as those defined in commonly used dictionaries) should be interpreted as having a meaning consistent with its meaning in the related technology and/or the context of this specification and not it should be interpreted in an idealized or overly formal sense, unless it is clearly defined as such in this article.

The terms used in the present disclosure are only used for the purpose of describing specific embodiments and are not intended to limit the embodiments. As used in the present disclosure, the singular forms “a”, “one” and “the” are also intended to include plural forms, unless the context clearly indicates otherwise. It will be further understood that when used in this specification, the terms “comprises (comprising)” and/or “includes (including)” designate the existence of stated features, steps, operations, elements and/or components, but the existence or addition of one or more other features, steps, operations, elements, components, and/or groups thereof are not excluded.

Reference will now be made in detail to exemplary embodiments, discussed with regard to the accompanying drawings. In some instances, the same reference numbers will be used throughout the drawings and the following description to refer to the same or like parts. Unless otherwise stated, technical and/or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. For example, unless otherwise indicated, method steps disclosed in the figures may be rearranged, combined, or divided without departing from the envisioned embodiments. Similarly, additional steps may be added, or steps may be removed without departing from the envisioned embodiments. Thus, the materials, methods, and examples are illustrative only and are not intended to be necessarily limited.

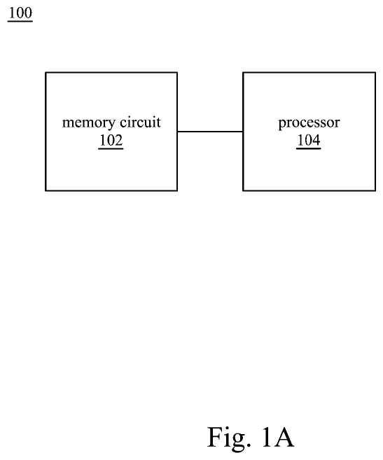

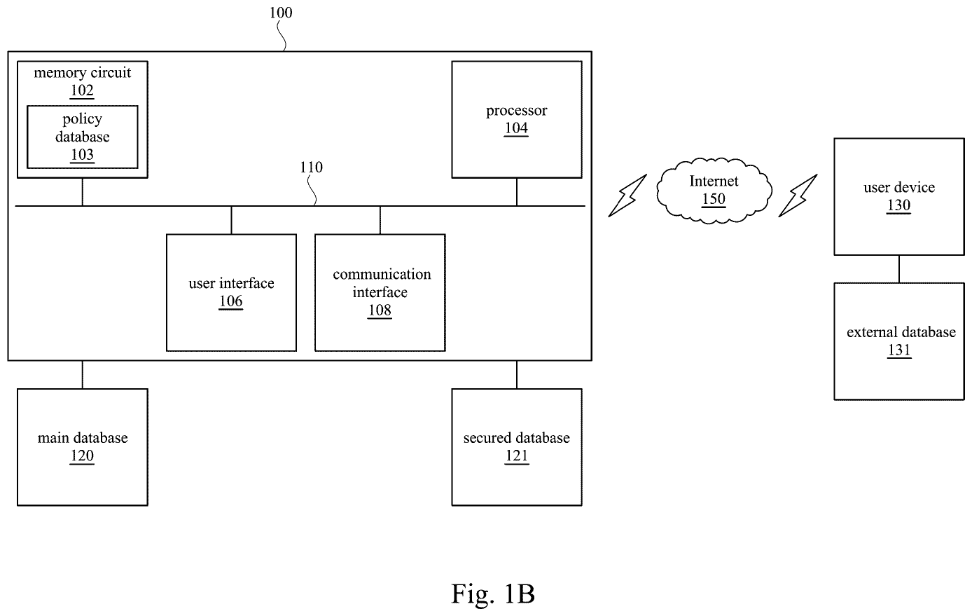

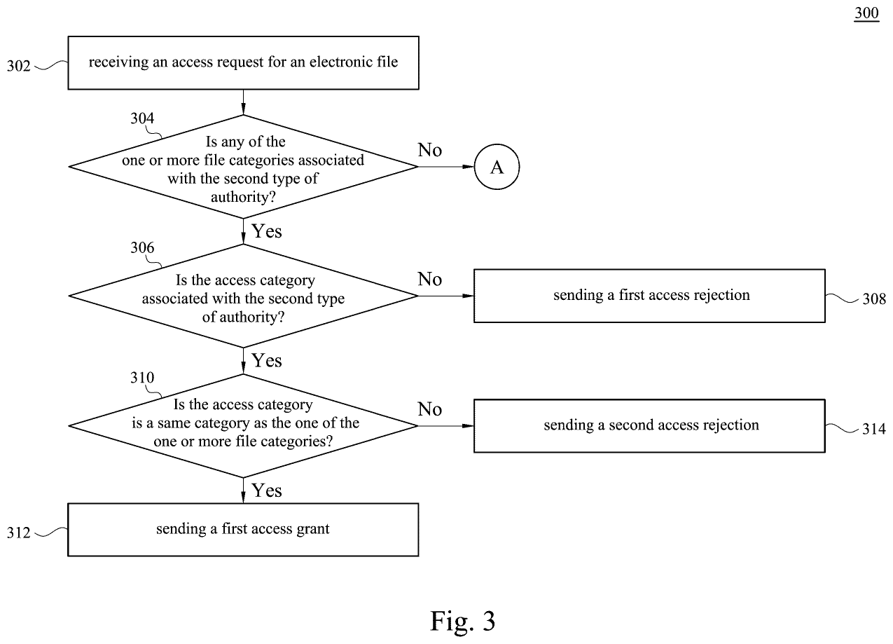

The present disclosure provides a method and system for access control of an electronic file. FIG. 1A is a schematic diagram of a system for access control of electronic files according to some embodiments of the present disclosure. As illustratively shown in FIG. 1A, the system 100 for access control of electronic files includes a memory circuit 102 and a processor 104. The memory circuit 102 stores a plurality of instructions that are used by the processing by the processor 104. For example, the processor 104 performs the instructions stored in the memory circuit 102 to realize a method 300 and method 400 for access control to electronic files in the main database 120. The method 300 and method 400 for access control to electronic files are disclosed in FIG. 3 to FIG. 5. In some embodiments, the memory circuit 102 includes, for example, a semiconductor device, a magnetic tape device, a magnetic disk device, or an optical disc device, or any combination thereof. In some embodiments, the instructions may also be installed from a non-transitory computer-readable recording medium, for example, a CD-ROM, a DVD-ROM, or the like to the memory circuit 102 using a publicly known setup program, or the like.

In another embodiment, as illustratively shown in FIG. 1B, the system 100 for access control of electronic files further includes a user interface 106 and a communication interface 108. Each of the memory circuit 102, the processor 104, the user interface 106, and the communication interface 108 is connected to a bus 110 to transmit data. Moreover, a main database 120 couples with the system 100. The main database 120 stores multiple electronic files. An administrator may operate the system 100 to assign one or more categories to the electronic files stored in the main database 120 and to manage permission categories of users or user groups.

In some embodiments, the user interface 106 is configured to provide an interface for assigning one or more categories to the electronic files and to manage a permission for an access category of a user or a user group. In some embodiments, the user interface may include virtual buttons displayed on a touch screen. A virtual button is a user-interface device that may provide a command based on a point of contact with the button by a user of the device. A button may also be used to provide one or more items for the user to select a command. The user may contact a virtual button on a touch screen surface to indicate a user command corresponding to the selection. Accordingly, an administrator may operate the user interface 106 to assign one or more categories to an electronic file and to manage a permission for an access category of a user or a user group.

In some embodiments, the electronic files are evidence files. “Category” may be a label assigned to an electronic file to define the nature and/or type of evidence, retention period, and user permission. It may also be optionally associated with additional metadata related to the evidence, such as user-defined forms. A plurality of categories may be assigned to an electronic file to define a plurality of evidence's natures, types, retention periods, and/or user permissions. If a user or a user group has permission to view one of the plurality of categories assigned to an electronic file, the user or the user group can access the electronic file. A “Category Type” is introduced to manage access permission for a few of the electronic files that require special authorization to view. An electronic file may have two types of file categories, including basic categories and exclusive categories. Different types of file categories correspond to different types of authority. The basic categories correspond to a first type of authority and the exclusive categories correspond to a second type of authority. In some embodiments, the administrator may operate the user interface 106 to assign one or more categories to the electronic file. For example, the administrator may operate the user interface 106 to assign the basic categories to the electronic files based on the evidence's nature, type, and retention period. The administrator may also operate the user interface 106 to assign the exclusive categories to the electronic files when the electronic files include information that requires special authorization to view. Therefore, once an electronic file is assigned with the exclusive category by the administrator, users or user groups having only the first type of authority, permission for an access category of a basic category assigned to the electronic file, cannot access this electronic file. In some embodiments, users or user groups have the first type of authority, permission for an access category of one or more basic categories assigned to one or more electronic files. The users or the user groups may access an electronic file when the users or the user groups have permission for any of one or more basic categories assigned to one or more electronic files and the electronic files are not assigned with any exclusive category. On the other hand, when users or user groups have the second type of authority, permission for an access category of one or more exclusive categories assigned to one or more electronic files, the user or the user groups may access electronic files when the users or the user groups have permission for any of one or more exclusive categories assigned to one or more electronic files.

In another embodiment, a classified category is also introduced to the present disclosure. Accordingly, when an electronic file includes evidence that is classified for a specific authority, the administrator may assign a classified category to the electronic file. Once the electronic file is assigned with the classified category, a user or a user group having only permission for a basic category assigned to the electronic file cannot access the electronic file. A user or a user group may have permission for one or more classified categories assigned to one or more electronic files. The user or the user group may access an electronic file if the user or the user group has permission for any of the classified categories assigned to the electronic file.

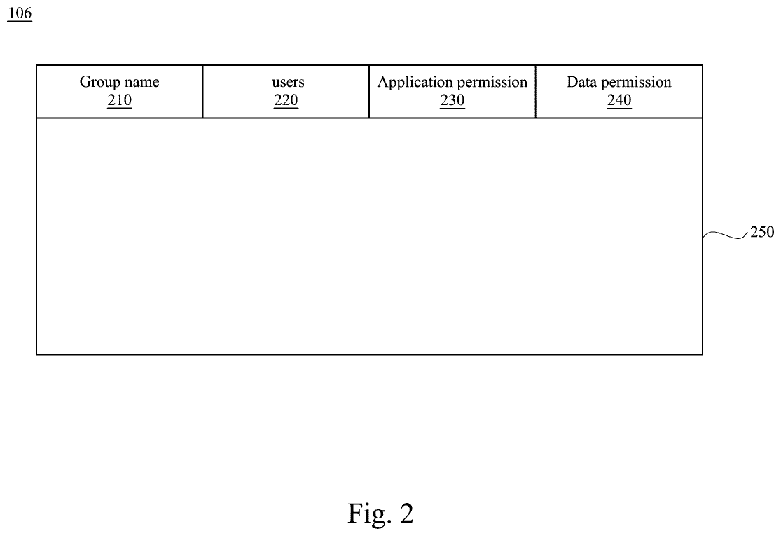

FIG. 2 illustrates an example of user interface for managing a permission for an access category of a user group for access to electronic files according to some embodiments of the present disclosure. As illustrated in FIG. 2, the user interface 106 includes multiple virtual buttons 210, 220, 230 and 240 and a display region 250. In some embodiments, the virtual buttons 210, 220, 230 and 240 correspond to section “Group name,” “users,” “Application permission,” and “Data permission,” respectively. In some embodiments, when the virtual button 210 corresponding to the section “Group name” is clicked by the administrator, the setting page of the “Group name” is displayed in the display region 250. The setting page of the “Group name” includes multiple input fields that allow administrators to set the group name and group description. Then, the administrators may click the virtual button 220 to display a corresponding setting page of the “users” in the display region 250. The setting page of the “users” includes multiple users. The administrators may select at least one user in the setting page of the “users” as a member of the set group name. Then, the administrators may click the virtual button 230 to display a corresponding setting page of the “Application permission” in the display region 250. The setting page of the “Application permission” includes multiple applications with different application scopes. The administrator can select at least one application for the set group name to execute. Then, the administrators may click the virtual button 240 to display a corresponding setting page of the “Data permission” in the display region 250. The setting page of the “Data permission” includes multiple items corresponding to different permissions for access categories and permission duration. The administrator can select one of the multiple items to set a permission for an access category and permission duration for the set group name. Accordingly, the at least one user in the set group name can access electronic files based on the set permission for an access category. However, the user interface 106 is not limited to the above.

In some embodiments, the communication interface 108 is configured to receive access requests of electronic files from users or user groups and to transmit electronic files accessed by users to a secured database and an external database of the users. In some embodiments, users (or user groups) may use user devices 130, such as computers or portable devices, to wireless communicate with the communication interface 108 through Internet 150 to transmit access requests of electronic files to the system 100. The system 100 may determine whether users (or user groups) may access the required electronic files based on the type of categories assigned to the electronic files and the type of permission for an access category assigned to the users (or user groups) by the administrator through the user interface 106.

In some embodiments, the memory circuit 102 further includes a policy database 103. The policy database 103 stores information regarding authority policy for the processor 104 to access for determining whether the electronic files accessed by users are associated with the authority policy. In some embodiments, the authority policy is about whether the electronic files accessed by user devices 130 are confidential. Therefore, once the processor 104 determines the electronic files accessed by user devices 130 are associated with the authority policy, the processor 104 may transmit the electronic files to a secured database 121 to store and to an external database 131 of users through the communication interface 108. In some embodiments, because the electronic files accessed by user devices 130 are confidential, the processor 104 encrypts the electronic files by a secret key before sending the electronic files to the external database 131. Then, the information about the secret key is sent to the external database 131 through the communication interface 108 by the processor 104. Accordingly, users can use the secret key to decrypt the electronic files.

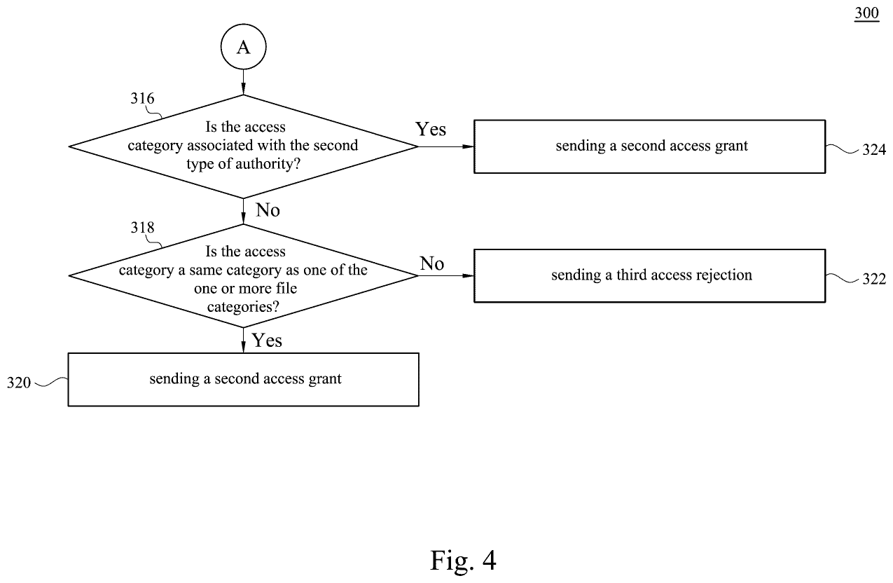

FIG. 3 is a flowchart diagram of a method 300 for access control to electronic files in accordance with some embodiments of the present disclosure. FIG. 4 is a flowchart diagram of the method 300 for access control to electronic files when file categories is not associated with the second type of authority in accordance with some embodiments of the present disclosure. In some embodiments, the processor 104 may access the instructions stored in the memory circuit 102 to perform to realize the method 300 for access control to electronic files. FIG. 1A to FIG. 4 are referred to together. The method 300 for access control to electronic files includes operation 302 to 324.

In the operation 302, receiving an access request for an electronic file is performed by a processor 104. In some embodiments, a user may use the user device 130 to communicate with the system 100 to transmit an access request to the processor 104 in the system 100 to require access to an electronic file. In some embodiments, the access request includes a permission for an access category. The electronic file is associated with one or more file categories assigned by an administrator, and each of the one or more file categories is associated with a first type of authority or a second type of authority. In some embodiments, the file categories have two types of file categories, including basic categories and exclusive categories. Different types of file categories correspond to different types of authority. Therefore, two types of file categories correspond to two types of authority, a first type of authority and a second type of authority. In some embodiments, the first type of authority is to allow the user to use the user device 130 to access the electronic files that are assigned the basic categories, and a second type of authority is to allow the user to access the electronic files that are assigned exclusive categories.

In the operation 304, determining whether any of the one or more file categories is associated with the second type of authority is performed by the processor 104. In some embodiments, when the processor 104 receive the access request from the user device 130 to require access an electronic file, the processor 104 may determine whether any of the one or more file categories assigned to the electronic file is associated with the second type of authority. For example, the second type of authority is to allow the user to use user device 130 to access the electronic files that are assigned exclusive categories. Therefore, the processor 104 may determine whether any of the one or more file categories assigned to the electronic file includes the exclusive categories.

If the processor 104 determines that any of the one or more file categories is associated with the second type of authority in the operation 304, the operation 306 is performed. In the operation 306, determining whether the access category is associated with the second type of authority is performed by the processor 104. In some embodiments, the second type of authority is to allow the user to access the electronic files that are assigned exclusive categories. Therefore, if the processor 104 determines that any of the one or more file categories assigned to the electronic file required by the user includes the exclusive categories, the processor 104 may determine whether the permission for an access category of the access request from the user is the second type of authority.

If the processor 104 determines that the access category is not associated with the second type of authority in the operation 306, the operation 308 is performed to send a first access reject. In some embodiments, the second type of authority is to allow the user to access the electronic files that are assigned exclusive categories. Therefore, if the any of the one or more file categories assigned to the electronic file required by the user includes the exclusive categories, but the permission for an access category of the access request from the user is not the second type of authority, that is, the permission for an access category does not include any of the exclusive categories, the processor 104 sends a first access reject to the user.

If the processor 104 determines that the access category is associated with the second type of authority in the operation 306, the operation 310 is performed. In the operation 310, determining whether the access category is a same category as the one of the one or more file categories is performed by the processor 104. In some embodiments, the second type of authority is to allow the user to access the electronic files that are assigned with exclusive categories. However, different exclusive categories have different conditions. Therefore, different electronic files may be assigned different exclusive categories based on the conditions required by the electronic files. Therefore, although the permission for an access category in the access request from the user is the second type of authority of allow access the electronic file that is assigned exclusive categories, the processor 104 will again determine whether the access category is a same category as the one of the one or more file categories assigned to the electronic file.

If the processor 104 determines that the access category is the same category as the one of the one or more file categories in the operation 310, the operation 312 is performed by the processor 104 to send a first access grant. In some embodiments, if the processor 104 determines that the access category is a same category as the one or more exclusive categories assigned to the electronic file, the processor 104 will send a first access grant to the user to allow the user to access the electronic files.

In contrast, if the processor 104 determines that the access category is different from the one of the one or more file categories in the operation 310, the operation 314 is performed by the processor 104 to send a second access rejection. In some embodiments, if the processor 104 determines that the access category is different from the one or more exclusive categories assigned to the electronic file, the processor 104 will send a second access rejection to the user to reject the user from accessing the electronic files.

In some embodiments, if the processor 104 determines that none of the one or more file categories is associated with the second type of authority in the operation 304, the operation 316 is performed as illustrated in FIG. 4. In the operation 316, determining whether the access category is associated with the second type of authority is performed by the processor 104. In some embodiments, the second type of authority is to allow the user to access the electronic files that are assigned exclusive categories. Therefore, if the processor 104 determines that none of the one or more file categories is associated with the second type of authority, the one or more file categories are associated with the first type of authority. The first type of authority is to allow the user to access the electronic files that are assigned with the basic categories. Accordingly, the processor 104 may determine whether the permission for an access category of the access request from the user is the second type of authority.

If the processor 104 determines that the access category is not associated with the second type of authority in the operation 316, the operation 318 is performed. In the operation 318, determining whether the access category is a same category as the one of the one or more file categories is performed by the processor 104. In some embodiment, if the processor 104 determines that the access category is not associated with the second type of authority, the access category is associated with the first type of authority. The first type of authority is to allow the user to access the electronic files that are assigned the basic categories. However, different basic categories have different conditions. Therefore, different electronic files may be assigned different basic categories based on the conditions required by the electronic files. Therefore, although the permission for an access category in the access request from the user is the first type of authority of allow access the electronic file that is assigned basic categories, the processor 104 will again determine whether the access category is a same category as the one of the one or more file categories assigned to the electronic file.

If the processor 104 determines that the access category is the same category as the one of the one or more file categories in the operation 318, the operation 320 is performed by the processor 104 to send a second access grant. In some embodiments, if the processor 104 determines that the access category is a same category as the one or more basic categories assigned to the electronic file, the processor 104 will send a second access grant to the user to allow the user to access the electronic files.

In contrast, if the processor 104 determines that the access category is different from the one of the one or more file categories in the operation 318, the operation 322 is performed by the processor 104 to send a third access rejection. In some embodiments, if the processor 104 determines that the access category is different from the one or more basic categories assigned to the electronic file, the processor 104 will send a third access rejection to the user to reject the user from accessing the electronic files.

On the other hand, in the operation 316, determining whether the access category is associated with the second type of authority is performed by the processor 104. If the processor 104 determines that the access category is associated with the second type of authority in the operation 316, the operation 324 is performed to send a second access grant. In some embodiments, the second type of authority is to allow the user to access the electronic files that are assigned exclusive categories. Therefore, if any of the one or more file categories assigned to the electronic file required by the user includes the basic categories, when the permission for an access category of the access request from the user is the second type of authority, a second access grant is sent to the user to allow the user to access the electronic files. That is, regardless of whether the access category is the first type authority or the second type authority, electronic files assigned with basic categories only can be accessed.

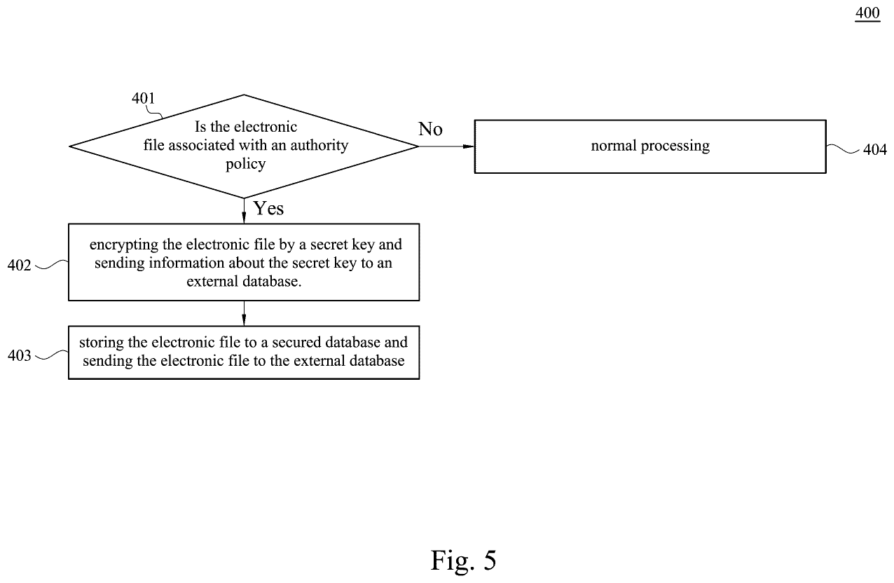

FIG. 5 is a flowchart diagram of a method 400 for access control to electronic files in accordance with another embodiment of the present disclosure. The method 400 for access control to electronic files further includes operations 401 to 404. FIG. 1A to FIG. 5 are referred together. It is noticed that the method 400 may be executed after the operation 302, and the method 400 may be executed simultaneously with the operation 304 to determine whether to encrypt the electronic file or not.

In the operation 401, determining whether the electronic file is associated with an authority policy is performed by the processor 104. In some embodiment, the memory circuit 102 includes a policy database 103. The policy database 103 stores information regarding authority policy. The processor 104 may determine whether the electronic file required by a user is associated with the authority policy. In some embodiments, the authority policy is about whether the electronic file required by a user is confidential.

Accordingly, once the processor 104 determines the electronic file required by the user is associated with the authority policy, the operation 403 is performed by the processor 104 to store the electronic file in a secured database and to send the electronic file to an external database in accordance with the authority policy. In some embodiments, the processor 104 may transmit the electronic file to a secured database 121 and to an external database 131 of the user through the communication interface 108. If the processor 104 determines the electronic file required by the user is not associated with the authority policy, in the operation 404, a normal process is performed (e.g., transmitting the electronic file without encryption).

In some embodiments, because the electronic files accessed by user devices 130 are confidential, before the processor 104 transmits the electronic file to the external database 131 of the user, the operation 402 is performed to encrypt the electronic file by a secret key by the processor 104 and send information about the secret key to the external database 131. In some embodiments, the processor 104 may encrypt the electronic file by the secret key before sending the electronic file to the external database 131. Then, the information about the secret key is sent to the external database 131 through the communication interface 108 by the processor 104. Accordingly, the user can use the secret key to decrypt the electronic file.

Another aspect of the disclosure is directed to a non-transitory computer-readable medium storing instructions which, when executed, cause one or more computers to perform the methods discussed above (e.g., the methods 300 and/or 400). The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be appreciated that the present disclosure is not limited to the exact construction that has been described above and illustrated in the accompanying drawings, and that various modifications and changes can be made without departing from the scope thereof. It is intended that the scope of the application should only be limited by the appended claims.

Moreover, while illustrative embodiments have been described herein, the scope thereof includes any and all embodiments having equivalent elements, modifications, omissions, combinations (e.g., of aspects across various embodiments), adaptations and/or alterations as would be appreciated by those in the art based on the present disclosure. For example, the number and orientation of components shown in the exemplary systems may be modified. Further, with respect to the exemplary methods illustrated in the attached drawings, the order and sequence of steps may be modified, and steps may be added or deleted. Furthermore, while some of the exemplary embodiments of the computerized methods were described using Java language or C to illustrate exemplary scripts and routines, the disclosed methods and systems may be implemented using alternative languages. The disclosed embodiments may use one or multiple programming languages in addition to Java or C. For example, the disclosed embodiments may also be implemented using Python, C++, C#, R, Go, Swift, Ruby, and/or their combinations.

Thus, the foregoing description has been presented for purposes of illustration only. It is not exhaustive and is not limiting to the precise forms or embodiments disclosed. Modifications and adaptations will be apparent to those skilled in the art from consideration of the specification and practice of the disclosed embodiments.

The claims are to be interpreted broadly based on the language employed in the claims and not limited to examples described in the present specification, which examples are to be construed as non-exclusive. Further, the steps of the disclosed methods may be modified in any manner, including by reordering steps and/or inserting or deleting steps.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A system for access control to electronic files, the system comprising:
a memory storing instructions; and
at least one processor in electronic communication with the memory, the at least one processor configured to execute the instructions to:
receive an access request for an electronic file, wherein the access request includes a permission for an access category, the electronic file is associated with one or more file categories, and each of the one or more file categories is associated with a first type of authority or a second type of authority;
determine whether any of the one or more file categories is associated with the second type of authority; and
in response to a determination that one of the one or more file categories is associated with the second type of authority:
determine whether the access category is associated with the second type of authority;
in response to a determination that the access category is not associated with the second type of authority, send a first access rejection; and
in response to a determination that the access category is associated with the second type of authority:
determine whether the access category is a same category as the one of the one or more file categories;
in response to a determination that the access category is the same category as the one of the one or more file categories, send an access grant; and
in response to a determination that the access category is different from the one of the one or more file categories, send a second access rejection.

2. The system of claim 1, wherein the access grant is a first access grant, and the at least one processor is further configured to execute the instructions to:
in response to a determination that none of the one or more file categories is associated with the second type of authority:
determine whether the access category is associated with the second type of authority; and
in response to a determination that the access category is not associated with the second type of authority:
determine whether the access category is a same category as one of the one or more file categories;
in response to a determination that the access category is the same category as the one of the one or more file categories, send a second access grant; and
in response to a determination that the access category is different from any of the one or more file categories, send a third access rejection.

3. The system of claim 1, wherein the access grant is a first access grant, and the at least one processor is further configured to execute the instructions to:
in response to a determination that none of the one or more file categories is associated with the second type of authority:
determine whether the access category is associated with the second type of authority; and
in response to a determination that the access category is associated with the second type of authority, send a second access grant.

4. The system of claim 1, wherein the at least one processor is further configured to execute the instructions to:
determine whether the electronic file is associated with an authority policy; and
in response to a determination that the electronic file is associated with the authority policy:
store the electronic file in a secured database; and
send the electronic file to an external database in accordance with the authority policy.

5. The system of claim 4, wherein the at least one processor is further configured to execute the instructions to:
encrypt the electronic file by a secret key before sending the electronic file to the external database; and
send information about the secret key to the external database.

6. A method for access control to electronic files, the method comprising:
receiving an access request for an electronic file, wherein the access request includes a permission for an access category, the electronic file is associated with one or more file categories, and each of the one or more file categories is associated with a first type of authority or a second type of authority;
determining whether any of the one or more file categories is associated with the second type of authority; and
responsive to a determination that one of the one or more file categories is associated with the second type of authority:
determining whether the access category is associated with the second type of authority;
responsive to a determination that the access category is not associated with the second type of authority, sending a first access rejection; and
responsive to a determination that the access category is associated with the second type of authority:
determining whether the access category is a same category as the one of the one or more file categories;
responsive to a determination that the access category is the same category as the one of the one or more file categories, sending an access grant; and
responsive to a determination that the access category is different from the one of the one or more file categories, sending a second access rejection.

7. The method of claim 6, wherein the access grant is a first access grant, the method further comprising:
responsive to a determination that none of the one or more file categories is associated with the second type of authority:
determining whether the access category is associated with the second type of authority; and
responsive to a determination that the access category is not associated with the second type of authority:
determining whether the access category is a same category as one of the one or more file categories;
responsive to a determination that the access category is the same category as the one of the one or more file categories, sending a second access grant; and
responsive to a determination that the access category is different from any of the one or more file categories, sending a third access rejection.

8. The method of claim 6, wherein the access grant is a first access grant, the method further comprising:
responsive to a determination that none of the one or more file categories is associated with the second type of authority:
determining whether the access category is associated with the second type of authority; and
responsive to a determination that the access category is associated with the second type of authority, sending a second access grant.

9. The method of claim 6, further comprising:
determining whether the electronic file is associated with an authority policy; and
in response to a determination that the electronic file is associated with the authority policy:
storing the electronic file in a secured database; and
sending the electronic file to an external database in accordance with the authority policy.

10. The method of claim 9, further comprising:
encrypting the electronic file by a secret key before sending the electronic file to the external database; and
sending information about the secret key to the external database.

11. A non-transitory computer-readable medium storing instructions which, when executed, cause at least one processor to perform operations for access control to electronic files, the operations comprising:
receiving an access request for an electronic file, wherein the access request includes a permission for an access category, the electronic file is associated with one or more file categories, and each of the one or more file categories is associated with a first type of authority or a second type of authority;
determining whether any of the one or more file categories is associated with the second type of authority; and
responsive to a determination that one of the one or more file categories is associated with the second type of authority:
determining whether the access category is associated with the second type of authority;
responsive to a determination that the access category is not associated with the second type of authority, sending a first access rejection; and
responsive to a determination that the access category is associated with the second type of authority:
determining whether the access category is a same category as the one of the one or more file categories;
responsive to a determination that the access category is the same category as the one of the one or more file categories, sending an access grant; and
responsive to a determination that the access category is different from the one of the one or more file categories, sending a second access rejection.

12. The non-transitory computer-readable medium of claim 11, wherein the access grant is a first access grant, the operations further comprising:
responsive to a determination that none of the one or more file categories is associated with the second type of authority:
determining whether the access category is associated with the second type of authority; and
responsive to a determination that the access category is not associated with the second type of authority:
determining whether the access category is a same category as one of the one or more file categories;
responsive to a determination that the access category is the same category as the one of the one or more file categories, sending a second access grant; and
responsive to a determination that the access category is different from any of the one or more file categories, sending a third access rejection.

13. The non-transitory computer-readable medium of claim 11, wherein the access grant is a first access grant, the operations further comprising:
responsive to a determination that none of the one or more file categories is associated with the second type of authority:
determining whether the access category is associated with the second type of authority; and
responsive to a determination that the access category is associated with the second type of authority, sending a second access grant.

14. The non-transitory computer-readable medium of claim 11, wherein the operations further comprise:
determining whether the electronic file is associated with an authority policy; and
in response to a determination that the electronic file is associated with the authority policy:
storing the electronic file in a secured database; and
sending the electronic file to an external database in accordance with the authority policy.

15. The non-transitory computer-readable medium of claim 14, wherein the operations further comprise:
encrypting the electronic file by a secret key before sending the electronic file to the external database; and
sending information about the secret key to the external database.
